(19) United States
(12) Patent Application Publication
(10) Pub. No.: US 2026/0356304 A1
(43) Pub. Date: Nov. 12, 2026

(54) TAILGATE PADS FOR TAILGATES OF VARIOUS THICKNESSES AND METHODS OF INSTALLING THE SAME

(71) Applicant: SEND IT, LLC, Erie, CO (US)

(72) Inventor: Cole KRAMER, Erie, CO (US)

(21) Appl. No.: 19/589,114

(22) PCT Filed: Jun. 6, 2024
(86) PCT No.: PCT/US2024/032800

§ 371 Date: May 20, 2026

Related U.S. Application Data
(63) Continuation-in-part of application No. 18/370,483, filed on Sep. 20, 2023, now Pat. No. 12,654,527.

(51) Int. Cl. B60R 13/01; B60R 9/06; B62D 33/02

(52) U.S. Cl. CPC B60R 13/01; B60R 9/065; B62D 33/02

(57) ABSTRACT

This disclosure includes tailgate pads and methods for installing the same. Some tailgate pads include an inside panel, an outside panel, and a folding panel joining the inside panel to the outside panel, the folding panel having a width, a length that is smaller than the width, and pads extending along the width (e.g., for at least 90% thereof). In some tailgate pads, the folding panel includes one or more grooves, each extending along the width and separating adjacent ones of the pads in the lengthwise direction such that the adjacent pads are displaceable relative to one another along the groove and/or is configured such that at least one of the pads is removable from the folding panel.

### CROSS-REFERENCE TO RELATED APPLICATION

This application claims priority to U.S. patent application Ser. No. 18/370,483, filed on Sep. 20, 2023 and entitled “TAILGATE PAD,” the entire contents of which are hereby incorporated by reference.

### BACKGROUND

### A. Field of the Invention

The present disclosure relates generally to tailgate pads, including but not limited to, tailgate pads that fit and protect tailgates having a variety of thicknesses.

### B. Description of Related Art

Often a vehicle having a tailgate, such as a pickup truck, is used to transport an item. In some instances, the item is supported using the tailgate. This can be the case when, for example, the item is too long to lay flat in a bed of the vehicle and/or security of the item relative to the bed would be enhanced via supporting the item with the tailgate. As one example, a bicycle will sometimes be positioned straddling the tailgate, with the front wheel positioned outside of the tailgate. Transporting items in this way, however, can cause damage to the tailgate and/or the items that are transported.

To minimize or prevent this damage, a tailgate pad can be attached to the tailgate. Tailgates, however, come in a variety of sizes and shapes, rendering existing tailgate pads, at a minimum, a poor fit for many applications, with protective pads thereof either being inadequate to protect the tailgate or the transported item from damage and/or misplaced such that the tailgate pad does not sufficiently conform to the tailgate.

### SUMMARY OF THE INVENTION

The present tailgate pads can address one or more of these drawbacks. In particular, some of the present tailgate pads can include an inside panel, an outside panel, and a folding panel joining the inside panel to the outside panel, where the folding panel includes pads and grooves that extend along the width of the folding panel to separate adjacent ones of the pads such that the adjacent pads are foldable, stackable, or otherwise angularly displaceable about the groove. In this way, for example, the folding panel provides locations—i.e., grooves—along which the folding panel can more readily be folded such that the folding panel can overlie the tops of tailgates having varying thicknesses, with, in some instances, other portions of the folding panel overlying bed-facing and/or exterior-facing surfaces of the tailgate. Additionally or alternatively, at least one of the folding panel's pads can be removable, which likewise enhances conformability of the folding panel with a tailgate's top, even without the above-described grooves.

Some of the present tailgate pads comprise: an inside panel, an outside panel, and a folding panel joining the inside panel to the outside panel, the folding panel comprising a width, a length that is smaller than the width, and pads that extend along the width. The pads can extend along the width for at least 90% of the width and can be separated by one or more grooves, each extending along the width and separating adjacent ones of the pads in the lengthwise direction such that the adjacent pads are displaceable relative to one another about the groove (e.g., an axis aligned therewith). In some embodiments, each of the groove(s) has a depth that is between 10 and 75 millimeters (mm). Additionally, or alternatively, at least one of the pads can be removable from the folding panel. In some tailgate pads, the at least one removable pad extends along the width of the folding panel for at least 50%, optionally at least 90%, of the width of the folding panel. In some tailgate pads, the folding panel defines a sleeve configured to receive the at least one removable pad.

In some tailgate pads, at least one of the pads—removable or not—extends along a width of the folding panel for at least 90% of the width of the folding panel. In some tailgate pads, each of the pads extends along the width of the folding panel for at least 90% of the width of the folding panel. In some tailgate pads, each of the pads has a thickness that is between 10 and 75 mm. In some embodiments, at least one of the pads has an end with a thickness that tapers. In some tailgate pads, at least one of the pads has a width that is at least 1.10 times a width of at least one other of the pads. In some tailgate pads, for adjacent ones of the pads in the lengthwise direction, one of the adjacent pads has a width that is at least 1.10 times a width of the other of the adjacent pads. In some tailgate pads, the pads comprise at least three pads.

Some tailgate pads comprise straps configured to secure one or more items relative to the folding panel, wherein the folding panel is configured to be coupled to the straps along top(s) of one or more of the pads. In some tailgate pads, the folding panel is configured to be coupled to the straps along the tops of pads that are spaced from one another in the lengthwise direction.

In some tailgate pads, the outside panel includes pads that extend along a width of the outside panel. In some tailgate pads, a thickness of a first one of the pads of the outside panel is between 1.1 and 3.0 times a thickness of a second one of the pads of the outside panel. In some tailgate pads, the first pad is disposed closer to the folding panel than is the second pad.

In some tailgate pads, the outside panel defines an opening through the outside panel, and the tailgate pad includes a cover configured to selectively cover the opening. Some tailgate pads comprise a storage pocket coupled to the inside panel. Some tailgate pads comprise straps configured to couple the inside panel to the outside panel.

Some of the present methods for installing a tailgate pad comprise disposing a tailgate pad over a tailgate such that: an inside panel of the tailgate pad overlies a bed-facing surface of the tailgate, an outside panel of the tailgate overlies an exterior-facing surface of the tailgate (e.g., a surface opposite the bed-facing surface), and a folding panel of the tailgate pad that joins the inside panel to the outside panel overlies a top of the tailgate, and adjacent ones of pads of the folding panel that extend along a width of the tailgate are angularly displaced relative to one another. In some methods, a portion of the folding panel (e.g., once the folding panel is installed) overlies the exterior-facing surface of the tailgate or the bed-facing surface of the tailgate.

In some methods, the adjacent pads are angularly displaced relative to one another by an angle of at least 30 degrees. In some methods, the adjacent pads are separated by a groove of the folding panel. Some methods comprise removing at least one of the pads from the folding panel.

The term “coupled” is defined as connected, although not necessarily directly, and not necessarily mechanically. Two items that are “coupled” may be unitary with each other or may be connected to one another via one or more intermediate components or elements.

The terms “a” and “an” are defined as one or more unless this disclosure explicitly requires otherwise.

The term “substantially” is defined as largely, but not necessarily wholly, what is specified (and includes what is specified; e.g., substantially 90 degrees includes 90 degrees, and substantially parallel includes parallel), as understood by a person of ordinary skill in the art. In any disclosed embodiment, the terms “substantially,” “approximately,” and “about” may be substituted with “within 10% of” what is specified.

The phrase “and/or” means and or or. To illustrate, A, B, and/or C includes: A alone, B alone, C alone, a combination of A and B, a combination of A and C, a combination of B and C, or a combination of A, B, and C. In other words, “and/or” operates as an inclusive or.

The terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and containing”) are open-ended linking verbs. As a result, an apparatus that “comprises,” “has,” “includes,” or “contains” one or more elements possesses those one or more elements but is not limited to possessing only those one or more elements. Likewise, a method that “comprises,” “has,” “includes,” or “contains” one or more steps possesses those one or more steps but is not limited to possessing only those one or more steps.

Any embodiment of any of the apparatuses and methods can consist of or consist essentially of—rather than comprise/have/include/contain—any of the described elements, features, and/or steps. Thus, in any of the claims, the phrase “consisting of” or “consisting essentially of” can be substituted for any of the open-ended linking verbs recited above to change the scope of a given claim from what it would otherwise be using the open-ended linking verb.

The feature or features of one embodiment may be applied to other embodiments, even though not described or illustrated, unless expressly prohibited by this disclosure or the nature of the embodiments.

Some details associated with the embodiments described above and others are described below.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate identical structures. Rather, the same reference numbers may be used to indicate similar features or features with similar functionalities, as may non-identical reference numbers. In each of the figures described as to scale, the sizes of the depicted elements are accurate relative to each other for at least the embodiment shown.

FIG. 1A is a to-scale front view of a first embodiment of the present tailgate pads, which includes an inside panel, an outside panel, and a folding panel joining the inside panel to the outside panel.

FIG. 1B is a to-scale side view of the tailgate pad of FIG. 1A.

FIG. 2A is a to-scale front view of the folding panel of FIG. 1A's tailgate pad, showing widthwise-extending pads of the folding panel that can be angularly displaced relative to one another to facilitate the folding panel's conformance with the tops of tailgates having varying thicknesses.

FIG. 2B is a to-scale side view of the folding panel of FIG. 2A.

FIG. 2C is a side view of the folding panel of FIG. 2A, shown installed on a tailgate.

FIG. 3 is a perspective view of the folding panel of FIG. 2A, showing straps for coupling items to the tailgate pad.

FIGS. 4A-4C are to-scale front views of the outside panel of FIG. 1A's tailgate pad, showing a cover for an opening through the outside panel, where the cover can be slid relative to the outside panel (FIG. 4B) or removed from the outside panel (FIG. 4C) to expose the opening.

FIG. 5 is a to-scale view of a strap for installing FIG. 1A's tailgate pad on a tailgate.

FIG. 6A is a to-scale front view of a second embodiment of the present tailgate pads, which includes an inside panel, an outside panel, and a folding panel joining the inside panel to the outside panel.

FIG. 6B is a to-scale front view of the tailgate pad of FIG. 6A, showing a cover coupled to the outside panel slid relative to the outside panel to expose an opening through the outside panel.

FIG. 6C is a to-scale rear view of the tailgate pad of FIG. 6A.

FIG. 7A is a to-scale front view of the folding panel of FIG. 6A's tailgate pad, showing widthwise-extending pads of the folding panel that can be installed into and removed from sleeves of the folding panel.

FIGS. 7B and 7C depict flaps for enclosing one of the pads within one of the sleeves.

FIG. 8A is a to-scale front view of the folding panel of FIG. 7A, showing straps for coupling items to the tailgate pad.

FIG. 8B is a to-scale view of one of the straps of FIG. 8A.

FIG. 9 is a perspective view of a section of the outside panel of FIG. 6A's tailgate pad, the section being taken between lines 9-9 of FIG. 6A.

FIG. 10 is a front view of a third embodiment of the present tailgate pads, which includes an inside panel, an outside panel, and a folding panel joining the inside panel to the outside panel, where the outside panel includes lengthwise-extending pads.

FIG. 11 is a front view of the tailgate pad of FIG. 10 installed on a tailgate, with a wheel of a bicycle being disposed between adjacent ones of the lengthwise-extending pads.

FIGS. 12A-12D depict a method for installing one of the present tailgate pads on a tailgate and coupling an item to the tailgate pad.

### DETAILED DESCRIPTION

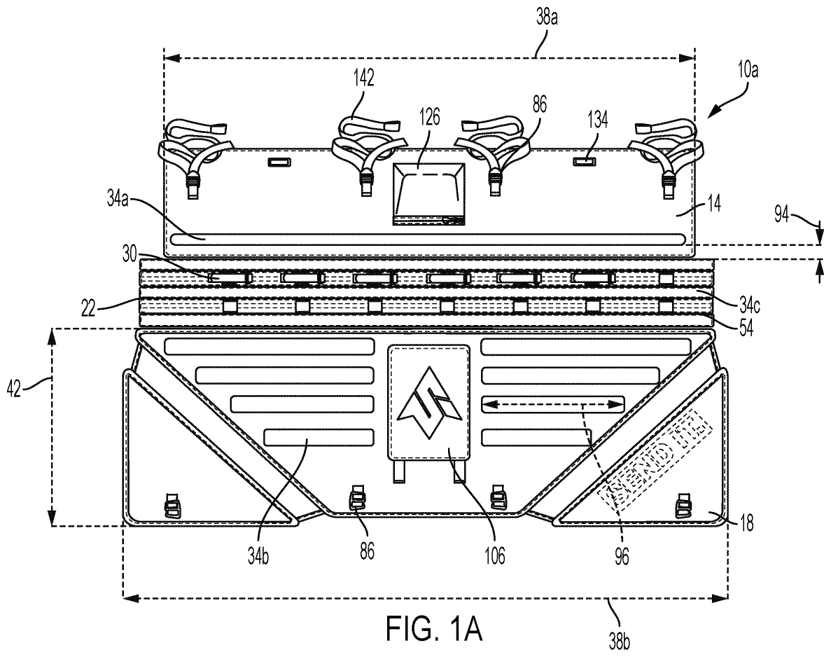

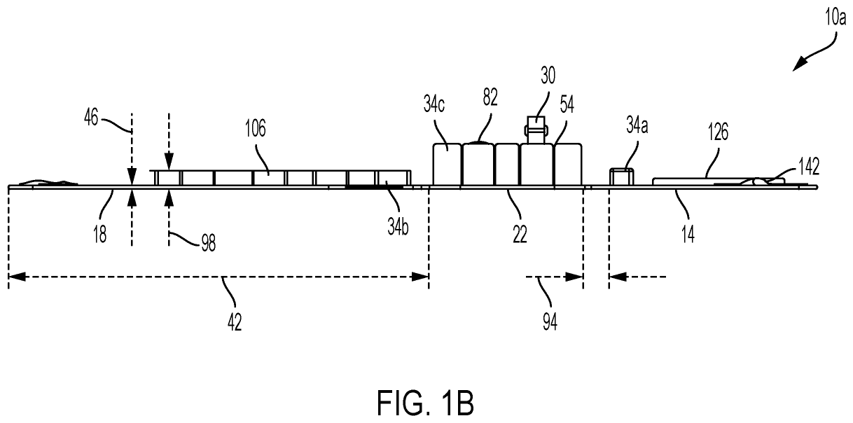

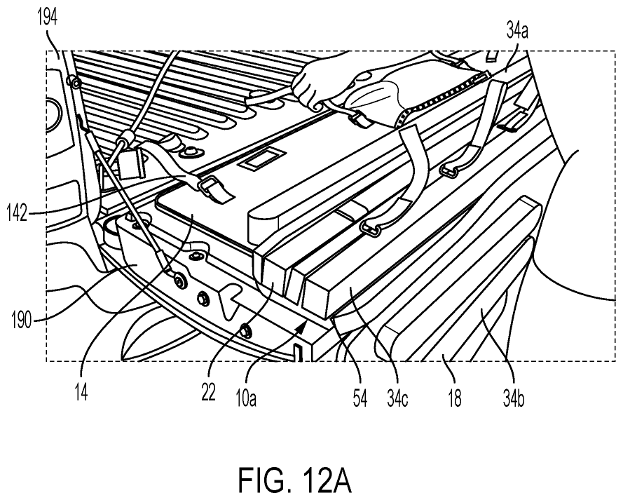

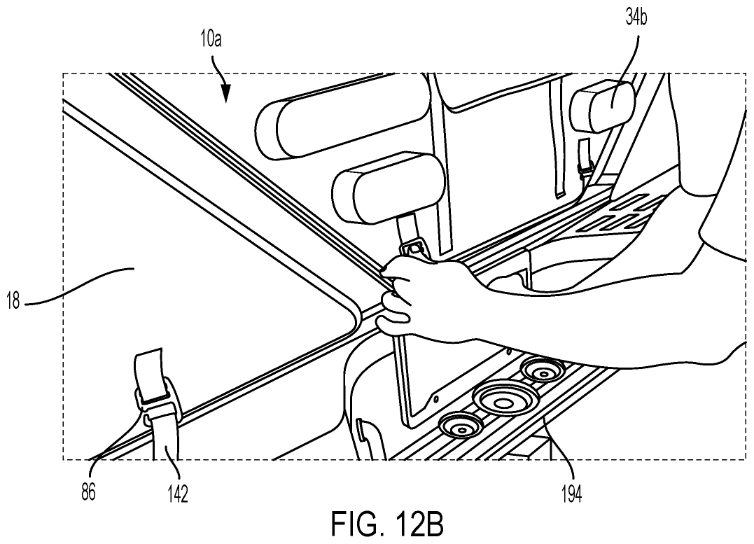

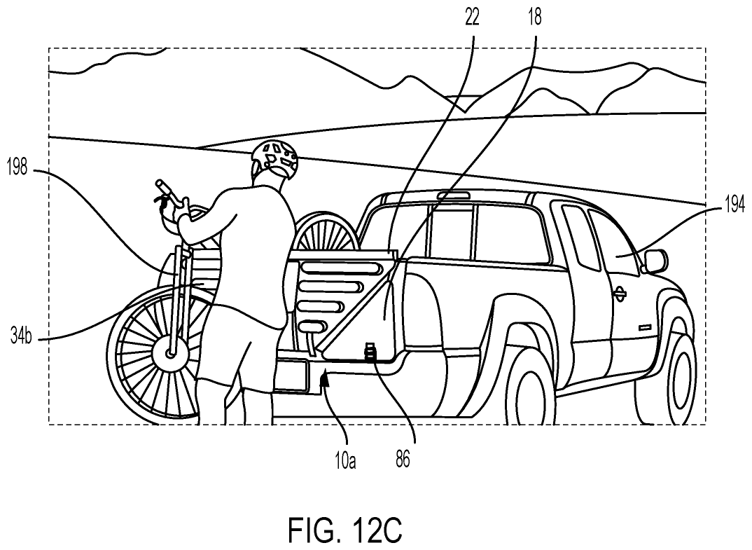

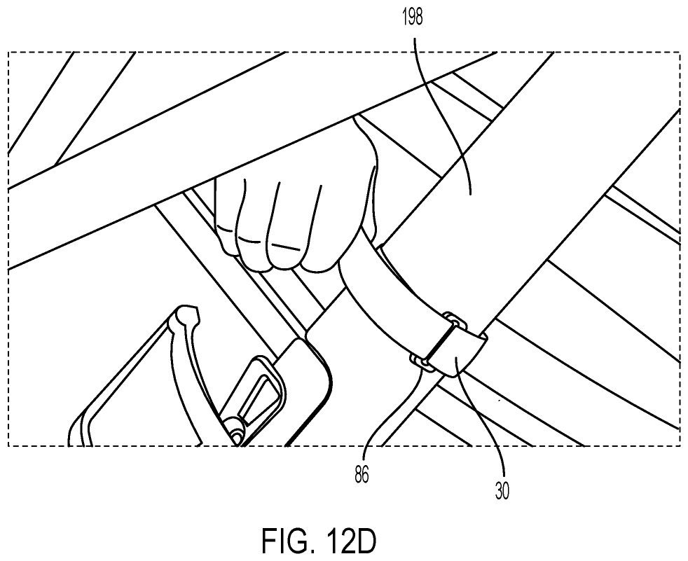

Referring now to the drawings, FIGS. 1A and 1B show a tailgate pad 10a. Tailgate pad 10a includes an inside panel 14, an outside panel 18, and a folding panel 22 joining the inside panel to the outside panel. When tailgate pad 10a is installed on a tailgate of a vehicle (e.g., tailgate 190 of vehicle 194, FIGS. 12A-12C), inside panel 14 can overlie a bed-facing surface of the tailgate, folding panel 22 can overlie a top surface of the tailgate, and outside panel 18 can overlie an exterior surface of the tailgate that is opposite the bed-facing surface. As illustrated, the vehicle can be a pickup truck. The present tailgate pads, however, can be installed on a tailgate of another type of vehicle, such as, for example, a utility vehicle (e.g., known as a “ute”), an SUV or van (e.g., having a split tailgate), and/or the like.

Tailgate pad 10a can facilitate transport of an item in a bed of the vehicle. For example, the item can be coupled to the tailgate pad via straps 30, described in more detail below, reducing the risk of the item shifting during transport, which can otherwise cause damage to the item, another item being transported, the tailgate, or other portion of the bed. As shown in the figures, the item can be a bicycle (e.g., 198, FIGS. 12C and 12D). Nevertheless, the present tailgate pads can facilitate the transport of any item, particularly when the item extends over the top of the tailgate during transport, including a motorcycle, a dirt bike, a snowboard, a surfboard, a paddleboard, a kayak, ski equipment, furniture, lumber, and/or the like.

To further protect the item and the tailgate, exterior surfaces of tailgate pad 10a can include pads 34a, 34b, and 34c. To illustrate, tailgate pad 10a has a pad 34a extending along inside panel 14, pads 34b extending along outside panel 18, and pads 34c extending along folding panel 22. These pads can absorb impacts between the item and the tailgate that might occur during placement of the item in the bed and during transport of the item, preventing, for example, the item from denting the tailgate. Pads 34a, 34b, and/or 34c can comprise, for example, a foam, such as a polyethylene, polyurethane, vinyl, ethyl-vinyl acetate, other polymer, and/or the like foam. Pads 34a, 34b, and 34c are described in more detail below. And to further protect the tailgate, interior surfaces of tailgate pad 10a—including those of inside panel 14, outside panel 18, and/or folding panel 22—can comprise a relatively soft material to mitigate scratches to the tailgate, such as to painted surfaces thereof, that might otherwise be caused by contact with the tailgate pad. Such a material can comprise, for example, fleece, microfiber, flannel, tricot, or other synthetic and/or natural textile, whether woven or nonwoven, which can comprise a polymeric material (e.g., nylon, polyester, and/or the like), a foam (e.g., a polymer foam, including any described above), and/or the like.

Exterior surfaces of tailgate pad 10a (as well as interior surfaces of the tailgate pad that do not overlie a painted surface of the vehicle), whether of inside panel 14, outside panel 18, and/or folding panel 22, can comprise a durable material, such as a polymer (e.g., nylon, polyamide, expanded polytetrafluoroethylene (e.g., GORE-TEX), polyester, polyvinyl chloride, polyurethane, high-density polyethylene, an aramid (e.g., KEVLAR, NOMEX, TECHNORA, and/or the like), silicone, and/or the like), rayon, and/or the like.

Tailgate pad 10a can be dimensioned to fit any one of a variety of tailgate sizes (e.g., a midsize truck's tailgate or a full size truck's tailgate). To illustrate, inside panel 14, outside panel 18, and folding panel 22 can each have a width (38a, 38b, and 38c, respectively) that is greater than or equal to any one of, or between any two of: 125, 130, 135, 140, 145, 150, 155, 160, 165, or 170 centimeters (“cm”). As shown, width 38a of inside panel 14 can be smaller than width 38b of outside panel 18 and/or width 38c of folding panel 22. In this way, for example, tailgate pad 10a can cover and protect larger portions of the tailgate, and in some instances, portions of the vehicle adjacent to the tailgate, with wider-width outside panel 18 and/or folding panel 22, while smaller-width inside panel 14 can reduce the chance of the tailgate pad becoming caught between the tailgate and the vehicle, such as when the tailgate is closed. Outside panel 18 can have a length 42 that is greater than or equal to any one of, or between any two of: 40, 45, 50, 55, 60, or 65 cm. Inside panel 14, outside panel 18, and folding panel 22 can have a thickness 46, measured through non-pad (e.g., 34a, 34b, and/or 34c) portions thereof, that is greater than or equal to any one of, or between any two of: 0.1, 0.2, 0.3, 0.4, 0.5, 0.75, 1.0, 1.25, 1.50, 1.75, or 2.0 cm.

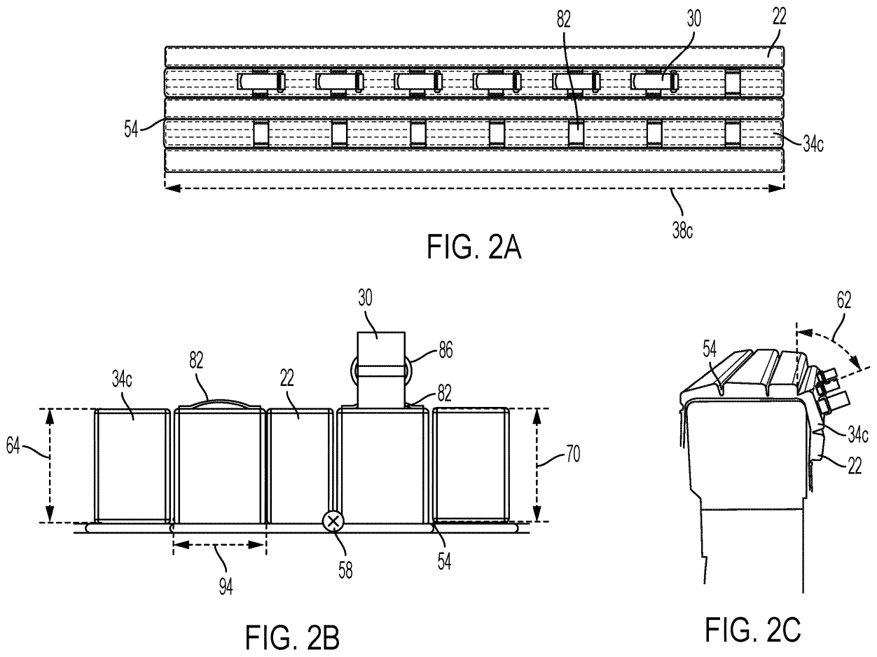

Referring additionally to FIG. 2A-2C, folding panel 22's pads 34c extend along width 38c of the folding panel. To illustrate, pads 34c can each extend along width 38c for 75, 80, 85, 90, 95%, or more, of the width. While as depicted, each individual one of pads 34c extends such percentage of width 38c, in other tailgate pads, distinct pads of a folding panel (e.g., a row of pads) can collectively extend such percentage of the folding panel's width. As shown, pads 34c include 5 pads, but other tailgate pads can include folding panels with more or less pads (e.g., 1, 2, 3, 4, 6, 7, 8, 9, 10, or more pads). Folding panel 22 further includes one or more widthwise-extending grooves 54 separating pads 34c from one another in a lengthwise direction that is measured perpendicularly to width 38c. In this way, for example, adjacent ones of pads 34c can be folded, unfolded, stacked, unstacked, or otherwise angularly displaced relative to one another along or about the one of grooves 54 that separates them, such as about an axis 58 aligned with the groove. To illustrate, an angle 62 achievable between adjacent ones of pads 34c can be greater than or equal to any one of, or between any two of: 25, 30, 35, 40, 45, 50, 55, 60, 65, 70, 75, 80, 85, or 90 degrees.

In this way, folding panel 22 can provide tailgate pad 10a with size adjustability to accommodate tailgates having various thicknesses without compromising the protection provided by pads 34c to the tailgate or an item transported thereon. To illustrate, for a thicker tailgate, a first number of pads 34c (e.g., 4) can overlie the top of the tailgate, and, for a thinner tailgate, a second, smaller number of the pads (e.g., 3) can overlie the top of the tailgate, with remaining one(s) of the pads (e.g., 1 pad 34c for the thicker tailgate and 2 pads 34c for the thinner tailgate) being angularly disposed to, for example, at least partially overlie the bed-facing surface and/or the exterior-facing surface of the tailgate. In either case, the top of the tailgate and any item transported thereon remains protected by pads 34c.

With folding panel 22's foldability provided by grooves 54, pads 34c can be relatively thick to provide increased protection without hindering the above-described size adjustability. To illustrate, each of pads 34c can have a thickness 64 that is greater than equal to any one of, or between any two of: 10, 15, 20, 25, 30, 35, 40, 45, 50, 55, 60, 65, 70, 75, or 80 mm (e.g., between 10 and 75 mm), and each of grooves 54 can correspondingly have a depth 70 that is greater than or equal to any one of, or between any two of: 10, 15, 20, 25, 30, 35, 40, 45, 50, 55, 60, 65, 70, 75, or 80 mm (e.g., between 10 and 75 mm). While pads 34c are shown as having the same thickness 64, in some embodiments, pads 34c can have differing thicknesses.

Pads 34c can have varying widths 74 (FIG. 2B). To illustrate, one or more of pads 34c can have a width 74 that is at least 1.10 times a width 74 of at least one other of the pads. More particularly, as shown, for adjacent ones of pads 34c in the lengthwise direction, one of the adjacent pads can have a width that is at least 1.10 times a width of the other of the adjacent pads; for example, the pads can alternate between wider and narrower pads in the lengthwise direction. Wider ones of pads 34c can, for example, provide increased protection to the tailgate and any item transported thereon as well as provide increased space for straps 30 for coupling items to the tailgate pad, and/or narrower ones of pads 34c can enhance foldability of folding panel 22.

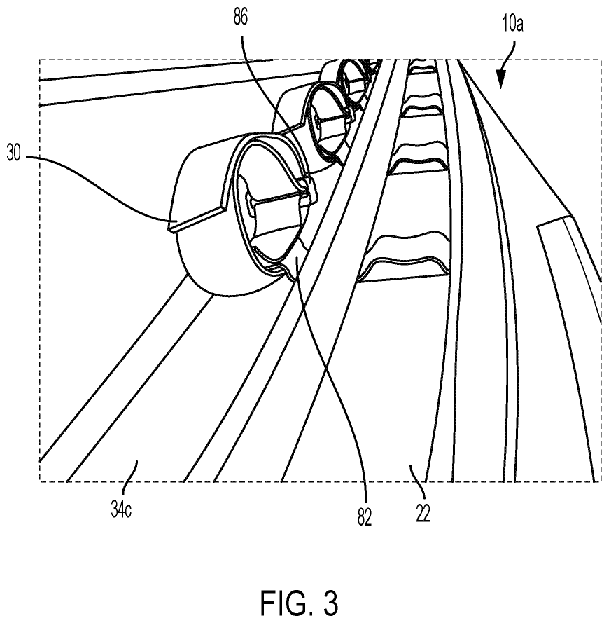

Referring additionally to FIG. 3, shown are tailgate pad 10a's straps 30 for securing one or more items relative to the tailgate pad. Straps 30 can be coupled to folding panel 22, such as along the tops of pads 34c. To illustrate, each of straps 30 can be received by a loop 82 of folding panel 22. Tailgate pad 10a can include any suitable number of straps 30, such as, for example, 1, 2, 3, 4, 5, 6, 7, 8, 9, 10, or more straps 30. And straps 30 can comprise any suitable material, including polyester, nylon, vinyl, canvas, HYPALON, and/or the like. To secure straps 30 to one or more items, and thus those item(s) to tailgate pad 10a, as well as inside panel 14 to outside panel 18 (as described below), the tailgate pad can include fasteners 86. Fasteners 86 can include any suitable fastener, such as a buckle (e.g., a tension lock buckle, a ladder lock buckle, a cam lock buckle, and/or the like), a cinch ring, a hook, a clip, a hook-and-loop fastener, and/or the like.

As described above, outside panel 18, similarly to folding panel 22, includes pads 34b. And also like folding panel 22, pads 34b of outside panel 18 can extend along width 38b of the outside panel. Each of pads 34b can have a thickness 98 (FIG. 1B), that is greater than or equal to any one of, or between any two of: 10, 15, 20, 25, 30, 35, 40, 45, or 50 mm, and such thickness may vary across the pads. The thickness of pads 34b, in some embodiments, can be selected such that an item coupled to tailgate pad 10a and in contact with one or more of the pads (e.g., a bicycle) does not contact the bumper of the vehicle on which the tailgate pad is installed (e.g., the front wheel of the bicycle does not contact the bumper). Such thickness, for each of pads 34b, can be smaller than thickness 64 of each of one or more of pads 34c. Pads 34b can each have a width 96 (FIG. 1A) that is greater than or equal to any one of, or between any two of: 10, 15, 20, 25, 30, 35, 40, 45, 50, 55, or 60 cm. As shown, one of pads 34b closer to folding panel 22 can have a larger width 96 than one of pads 34b farther from the folding panel; for example, pads 34b can consecutively increase in width 96 in a direction toward the folding panel. While pads 34b are shown as having square ends, in other tailgate pads, the ends of such pads can be round (e.g., semi-circular). Tailgate pad 10a includes 8 pads 34b, but other embodiments can have more or less (e.g., 1, 2, 3, 4, 5, 6, 7, 8, 9, 10, or more pads 34b).

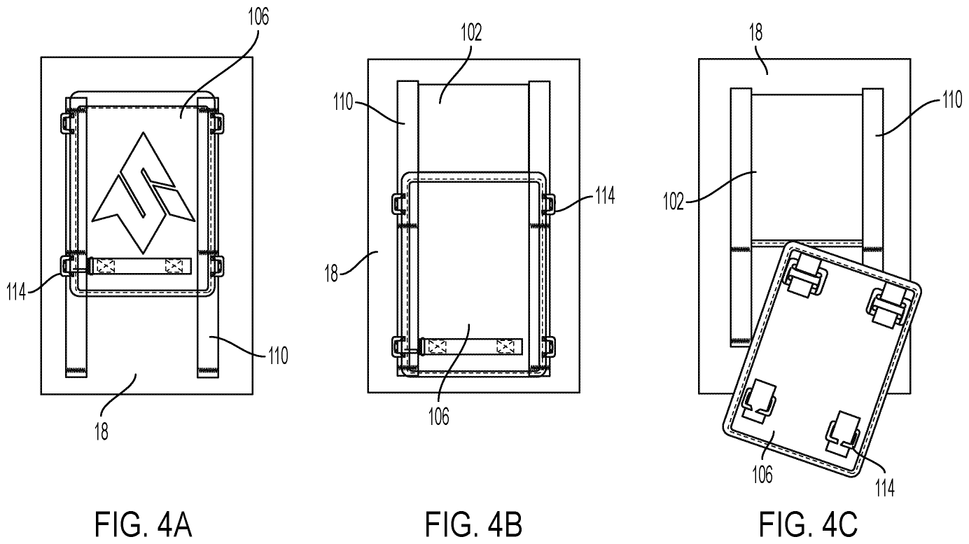

Referring additionally to FIGS. 4A-4C, outside panel 18 can define an opening 102 therethrough. Opening 102 can be positioned along outside panel 18 such that, when tailgate pad 10a is coupled to the tailgate, the opening permits access to, for example, a tailgate handle, a tailgate-mounted backup camera, another tailgate feature, and/or the like. As shown, opening 102 is rectangular; however, in other tailgate pads, such an opening can have any suitable shape.

Tailgate pad 10a can further include a cover 106 configured to selectively cover opening 102. For example, cover 106 can be coupled to outside panel 18 such that the cover is movable relative to the outside panel between a closed position (e.g., FIG. 4A) in which the cover blocks access to opening 102 and an open position (e.g., FIG. 4B) in which the cover permits access to the opening. When cover 106 is in the open position, at least a majority of, up to including all of, opening 102 can be exposed. Such can be achieved through a slidable coupling between cover 106 and outside panel 18. To illustrate, outside panel 18 can include straps 110 that extend along opposing sides of opening 102, and cover 106 can include clips 114 configured to receive and slide along the straps as the cover is moved between the closed and open positions. In tailgate pad 10a, cover 106 is captured by straps 110, with, for example the straps fixed to outside panel 18 at each of their ends to prevent clips 114 from sliding off of the straps. Straps 110 can comprise, for example, any of the materials described above for straps 30, and clips 114 can comprise rings, buckles, hooks, and/or the like. Cover 106 can comprise foam, a polymeric material, metal, and/or the like.

Straps 110 and clips 114 are provided for purposes of illustration; in otherwise similar tailgate pads, a cover (e.g., 106) can be slidably coupled to an outside panel (e.g., 18) along cords, rails (e.g., plastic, metal, and/or the like rails), piping, and/or the like of the outside panel, via slots and protrusions of the cover and outside panel, and/or the like. In some embodiments, a cover (e.g., 106) can be slid relative to an outside panel (e.g., 18) to an extent that the cover becomes decoupled from the outside panel (e.g., slid off straps, cords, rails, piping, slots, protrusions, and/or the like that couple the cover to the outside panel). In yet other embodiments, rather than be slidable relative to an outside panel (e.g., 18), a cover (e.g., 106) can comprise an openable flap (e.g., affixed to the outside panel along one of its edges) or a separate panel that is couplable and decouplable to the outside panel (e.g., using hook-and-loop fasteners, clips, snaps, other fasteners, and/or the like).

Inside panel 14's pad 34a can—and if multiple (e.g., as in a row of pads 34a), can collectively—extend along width 38a of the inside panel, such as along 50, 55, 60, 65, 70, 75, 80, 85, 90, 95%, or more, of the width. Pad 34a can, for example, provide impact protection between the interior facing surface of the tailgate and an item transported on the tailgate (e.g., for a frame of a bicycle that straddles the tailgate), even if none of pads 34c of folding panel 22 overlie the interior facing surface of the tailgate. As shown, pad 34a can be disposed close to folding panel 22; to illustrate, a lengthwise distance 94 between pad 34a and a nearest one of pads 34c of the folding panel (e.g., measured when tailgate pad 10a is laid flat, as shown in FIGS. 1A and 1B) can be less than or equal to any one of, or between any two of: 2.5, 3.0, 3.5, 4.0, 4.5, or 5.0 cm. Pad 34a can have any thickness described above for pads 34b of outside panel 18. While tailgate pad 10a includes a single pad 34a on its inside panel 14, in other embodiments, such an inside panel can include any suitable number of pads (e.g., 2, 3, 4, 5, or more pads).

Tailgate pad 10a can include one or more storage pockets, such as storage pocket 126 coupled to inside panel 14. As shown, storage pocket 126 can be openable and closable; for example, using a zipper. In other tailgate pads, such a storage pocket can be opened and closed via operation of a flap, hook-and-loop fasteners, snaps, buttons, hook-and-eye closures, buckles, magnets, and/or the like. Storage pocket 126 can have a width, measured in a widthwise direction of tailgate pad 10a (parallel to width 38a of inside panel 14), that is greater than or equal to any one of, or between any two of: 20, 25, 30, 35, 40, 45, 50, 55, 60, 65, 70, 75, 80, 85, 90, 100, 110, 120, or 140 cm (e.g., approximately 30 cm) and can have a length, measured perpendicularly to the width, that is greater than or equal to any one of, or between any two of: 5, 10, 15, 20, 25, or 30 cm (e.g., approximately 23 cm). Further, storage pocket 126 can have a depth, measured perpendicularly to its width and its length, that is between 2 and 8 cm (e.g., between 3 and 6 cm). While tailgate pad 10a is shown as including a single storage pocket 126 that is coupled to inside panel 14, other tailgate pads can include any suitable number of such storage pockets, each of which can be coupled to an inside panel (e.g., 14) or an outside panel (e.g., 18) of the tailgate pad.

Tailgate pad 10a can further include one or more locking holes 134 configured to reduce the risk of the tailgate pad being stolen. To illustrate, tailgate pad 10a includes two locking holes 134, each defined through inside panel 14. Locking holes 134 can be configured to receive a lock (e.g., a cable lock) to secure tailgate pad 10a to the vehicle. To mitigate damage to tailgate pad 10a that might be caused by the lock, locking holes 134 can be reinforced, such as by gromets, reinforcing layers (e.g., BRAVOTABs), webbing (e.g., grosgrain webbing), and/or the like. Provided by way of illustration, locking holes 134 can each have a length ranging from 2 to 6 cm (e.g., approximately 4 cm), and a width ranging from 3 to 10 cm (e.g., approximately 8 cm).

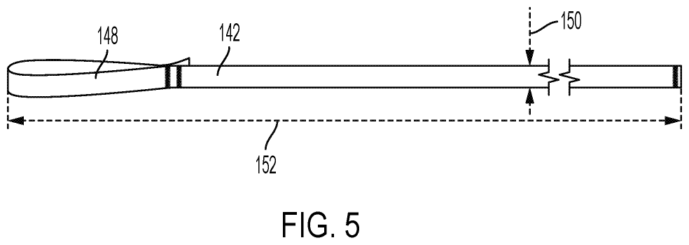

Referring additionally to FIG. 5, tailgate pad 10a can include straps 142 configured to couple inside panel 14 to outside panel 18 around the tailgate. To illustrate, straps 142 can be coupled to inside panel 14. Such coupling can be adjustable, with, for example, straps 142 coupled to inside panel 14 via fasteners 86, including any of those described above, or fixed (e.g., via stitching). For each of straps 142, an end of the strap opposite that coupled to inside panel 14 can be configured to be coupled to a fastener 86 that is coupled to outside panel 18. To illustrate, the outside-panel end of the strap can define a loop 148 that can receive a hook of the fastener coupled to outside panel 18. In one or more of these ways, the strap can be passed from inside panel 14, through a gap between the tailgate and the vehicle, attached to outside panel 18, and tightened via the inside-panel and/or outside-panel side's fastener 86 to secure tailgate pad 10a relative to the tailgate. Of course, such tightening can—additionally or alternatively—be achieved via tightening of a fastener 86 positioned along the strap.

Straps 142 can comprise any of the materials described above for straps 30. And each of straps 142 can have a width 150 that is between 1.5 and 5 cm (e.g., approximately 2.5 cm) and a length 152 that is between 50 and 120 cm (e.g., approximately 70 mm). Further, straps 142 can be coupled to inside panel 14 and outside panel 18 in a way that prevents fasteners 86 involved therewith from contacting the tailgate, minimizing damage to the tailgate. To illustrate, any fasteners 86 of outside panel 18 can be positioned on an exterior surface of the outside panel and above a bottom of the outside panel (e.g., 2 to 4 cm above thereof). While tailgate pad 10a includes 4 straps 142, other tailgate pads can include more or less straps (e.g., 142), such as 2, 3, 5, 6, or more of the straps, which can be positioned along the tailgate pad (e.g., in a widthwise direction thereof) at any suitable spacing.

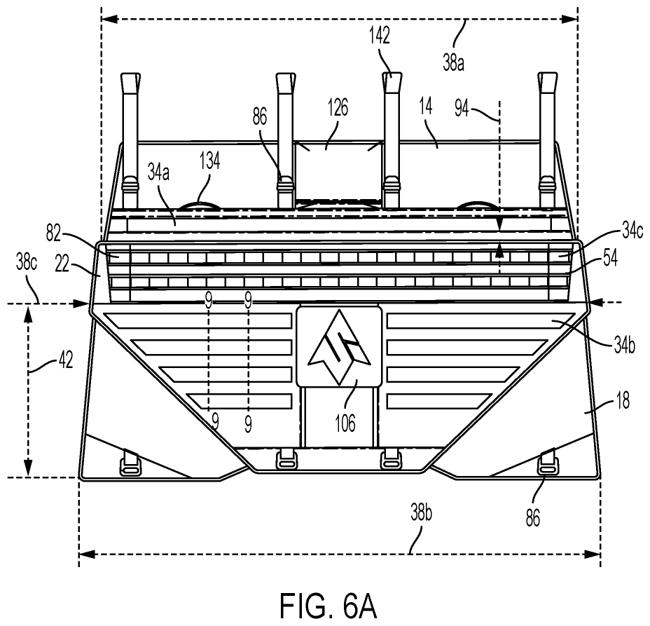

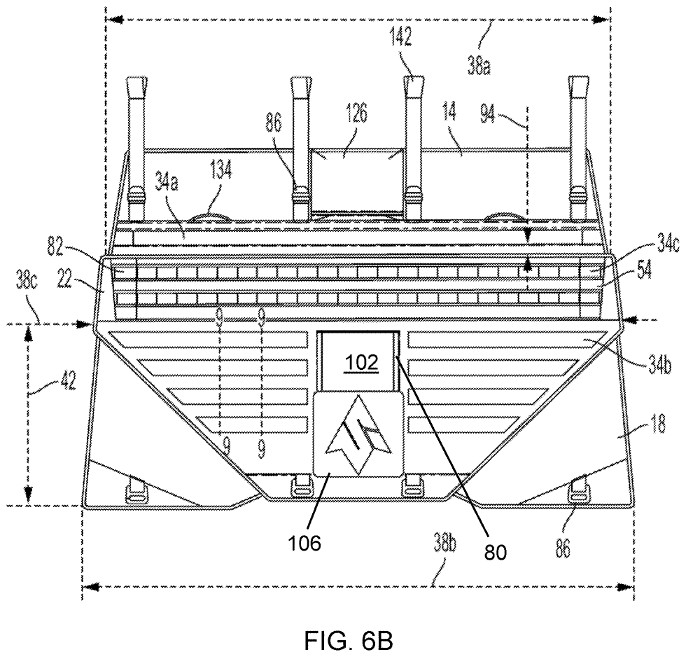

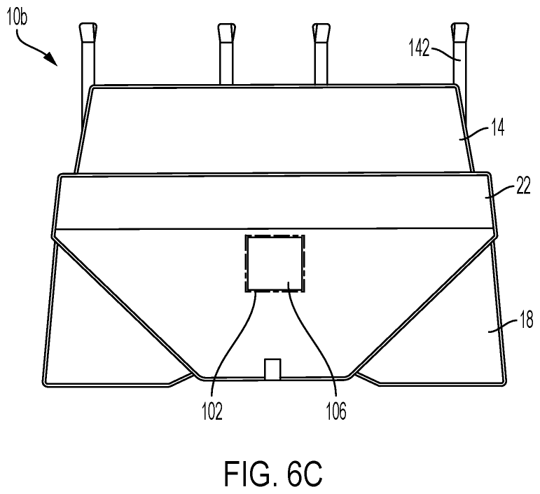

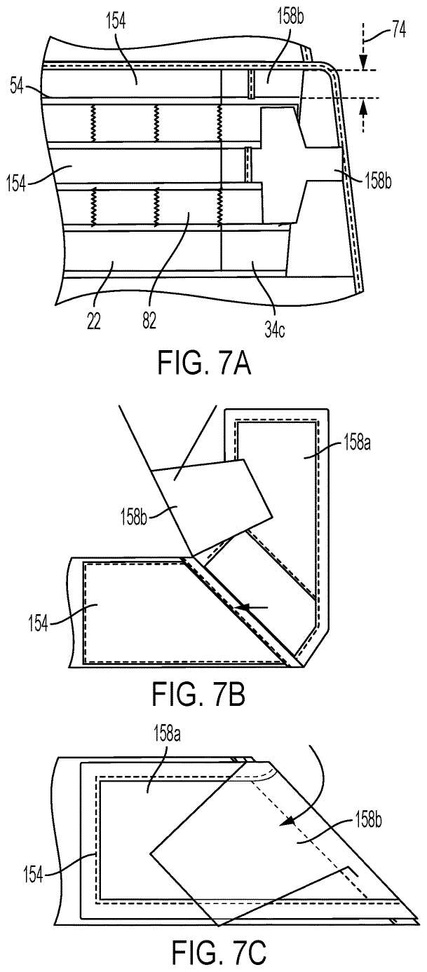

Referring now to FIGS. 6A-7C, shown is a second embodiment 10b of the present tailgate pads. Tailgate pad 10b can be substantially similar to tailgate pad 10a, with the primary exceptions described below. In tailgate pad 10b, at least one (e.g., 2, 3, 4, or more of, up to including all of) of pads 34c can be removable from folding panel 22. In the depicted embodiment, for example, the first closest one of pads 34c to inside panel 14 and the third closest one of pads 34c can be removable from the folding panel, pads 34c without loops 82 disposed thereon can be removable, and/or the like. To illustrate, folding panel 22 can define one or more sleeves 154, each configured to removably receive a removable one of pads 34c. And those sleeve(s) can each include one or more flaps for securing the removable pad therein or otherwise closing the sleeve. To illustrate, a sleeve 154 can include two flaps, 158a and 158b, where flap 158a is first secured to the remainder of the sleeve, and flap 158b is subsequently secured to the remainder of the sleeve, such as to then-closed first flap 158a. This configuration, though not required, can mitigate moisture or contaminate ingress into the sleeve. Sleeve(s) 154 are provided by way of example, as one or more of pads 34c can be removable in other ways, including through detaching those pad(s) through hook-and-loop, snaps, or other fasteners from tailgate pad 10b. In any event, removing those pad(s) facilitates the tailgate pad's foldability (even if along then-empty sleeve(s) 154), and thus tailgate pad 10b's ability to accommodate tailgates of various sizes.

A removable pad 34c can extend along width 38c of folding panel 22 for greater than or equal to any one of, or between any two of: 50, 55, 60, 65, 70, 75, 80, 85, 90, or 95% of that width (e.g., for at least 50%, optionally at least 90% of, the width of the folding panel). Further, at least one of pads 34c can have an end with a thickness 66 that tapers (FIG. 7C). Such a tapering thickness can accommodate, for example, a tonneau cover of the vehicle when such pad(s) are present.

Tailgate pad 10b also illustrates an embodiment of the tailgate pads that uses piping 80 to support a cover 106 as it is slid relative to outside panel 18 between a closed position in which it prevents access to at least a portion of an opening 102 through the outside panel (FIG. 6A) and an open position in which it permits access to at least a portion of the opening (FIG. 6B). In particular, cover 106 of tailgate pad 10b includes clips configured to slide along piping 80 of outside panel 18 as the cover is moved between the closed and open positions. That cover can, in some instances, be removed from outside panel 18 by, for example, sliding the cover toward folding panel 22 and/or in an opposing direction such that the clips of the cover become disengaged from piping 80. The configuration of piping 80 and the clips of cover 106 can be described as including piping clips, wing clips, or sternum sliders.

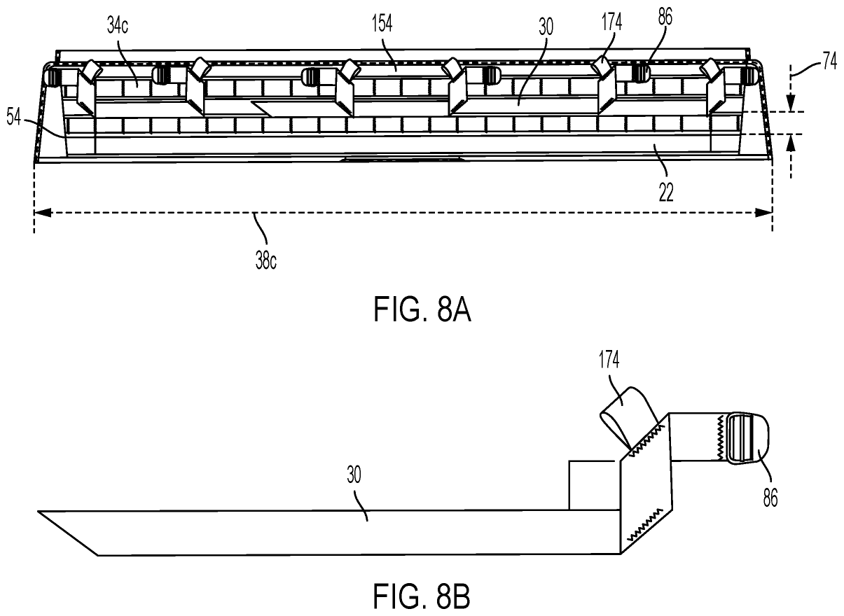

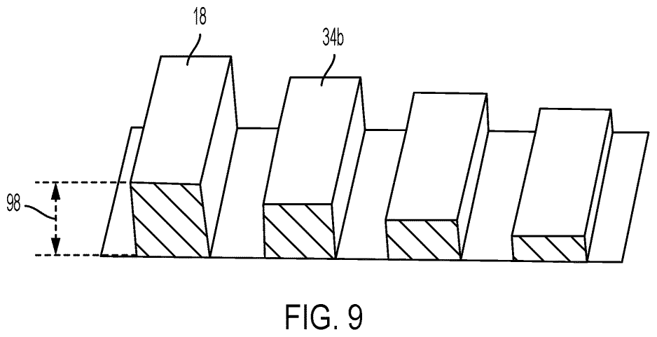

Referring now to FIGS. 8A and 8B, straps 30 of tailgate pad 10b can each include a loop 174 (e.g., an elastic loop) and a fastener 86. To illustrate the use of one of tailgate pad 10b's straps 30 to couple an item to a tailgate pad, strap 30 can be passed through a loop 82 of the tailgate pad, and the remainder of the strap can be wrapped around the item, passed through loop 174 of the strap, and tightened via the strap's fastener 86. As shown, loops 82 of tailgate pad 10b can be disposed in rows of loops, as in MOLLE webbing, providing increased flexibility with respect to where items can be secured to the tailgate pad.

Turning to FIG. 9, as to outside panel 18 of tailgate pad 10b, a thickness 98 of a first one of pads 34b can be greater than or equal to any one of, or between any two of: 1.1, 1.2, 1.3, 1.4, 1.5, 2.0, 2.5, or 3.0 times (e.g., between 1.1 and 3.0 times), a thickness 98 of a second one of pads 34b. The first pad can be disposed closer to folding panel 22 than is the second pad. To illustrate, pads 34b can consecutively increase in thickness 98 in a direction toward folding panel 22. This configuration can, for example, facilitate the transport of certain items, such as a bicycle straddling the tailgate with a front wheel thereof abutting pads 34b. To illustrate, being a wheel, the front wheel will have a narrower transverse dimension near its top than it does near its middle, which can be accommodated by pad 34b's thicknesses.

Tailgate pad 10a, tailgate pad 10b, and tailgate pad 10c (described below) can each have any of the features described with respect to any other of the tailgate pads. For instance, tailgate pad 10a can include removable pads (e.g., 34c) as described for tailgate pad 10b, and tailgate pad 10b's folding panel 22 can be foldable in the manner described for tailgate pad 10a's folding panel 22—e.g., employing grooves 54 between pads 34, including removable ones thereof.

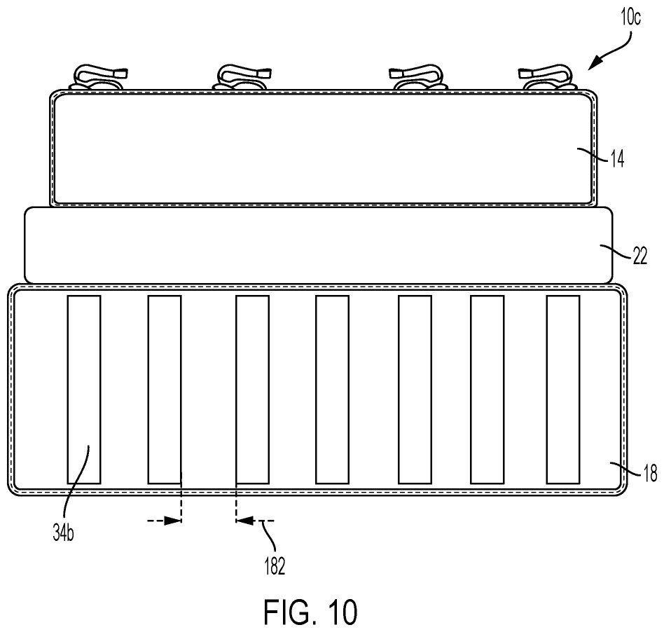

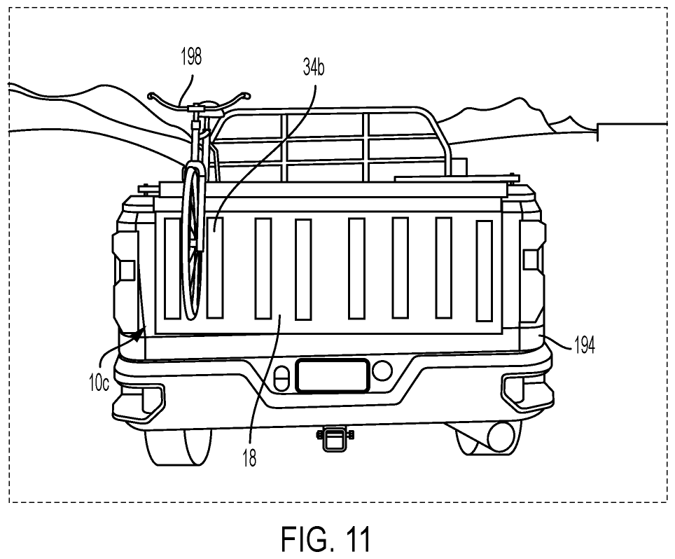

Turning now to FIGS. 10 and 11, shown is a third embodiment 10c of the present tailgate pads. Tailgate pad 10c can be substantially similar to tailgate pad 10a, with the primary exception being the configuration of outside panel 18's pads 34b. As shown, pads 34b extend along length 42 of outside panel 18, rather than along its width 38b. This configuration can be particularly beneficial when transporting certain items; for instance, a bicycle straddling the tailgate can have its front wheel received between adjacent ones of pads 34b, limiting movement of the wheel during transportation, which might otherwise damage the bicycle, the tailgate, or another item being transported. To illustrate, a width-wise distance 182 between adjacent ones of pads 34b can be greater than any one of, or between any two of 40, 50, 60, 70, 80, 90, 100, 110, 120, 130, and 140 mm.

Referring to FIGS. 12A-12D, shown is a method for coupling a tailgate pad (e.g., 10a, 10b, 10c, or the like) to a tailgate (e.g., 190) of a vehicle (e.g., 194). As shown in FIG. 12A, the tailgate pad can be placed on the tailgate when the tailgate is in an open position such that an inside panel (e.g., 14) of the tailgate pad overlies a surface of the tailgate that is bed-facing when the tailgate is in a closed position. Straps (e.g., 142) coupled to the inside panel can then be fed through a gap between the tailgate and the bed. Turning to FIG. 12B, the tailgate can then be moved toward or to the closed position, a folding panel (e.g., 22) of the tailgate pad can be disposed over a top surface of the tailgate, and an outside panel (e.g., 18) of the tailgate pad can be disposed over an exterior-facing surface of the tailgate. The straps can then be coupled to the outside panel and tightened, whether via fasteners (e.g., 86) coupled to the inside panel and/or fasteners (e.g., 86) coupled to the outside panel.

While disposing the tailgate pad over the top and exterior-facing surfaces of the tailgate and/or attaching the straps and tightening the fasteners, adjacent ones of pads (e.g., 34c) of the folding panel that extend along a width of the tailgate can be angularly displaced relative to one another, such as by an angle (e.g., 62) of at least 30 degrees. Such angular displacement can be about a groove (e.g., 54) of the folding panel. Additionally or alternatively, at least one of the pads can be removed from the folding panel. In either or both of these ways, the folding panel may conform to the top surface of the tailgate, with, for example, a portion of the folding panel overlying the exterior-facing surface of the tailgate and/or a portion of the folding panel overlying the bed-facing surface of the tailgate.

Referring to FIGS. 12C and 12D, an item to be transported can then be loaded into the bed of the vehicle. In this instance, the item is a bicycle (e.g., 198), with the bicycle's frame overlying the folding panel and the bicycle's front wheel abutting the outside panel. The item can then be secured relative to the tailgate pad, and thus the tailgate, via straps (e.g., 30), and optionally, via fasteners (e.g., 86).

The above specification and examples provide a complete description of the structure and use of illustrative embodiments. Although certain embodiments have been described above with a certain degree of particularity, or with reference to one or more individual embodiments, those of ordinary skill in the art could make numerous alterations to the disclosed embodiments without departing from the scope of this invention. As such, the various illustrative embodiments of the apparatuses and methods are not intended to be limited to the particular forms disclosed. Rather, they include all modifications and alternatives falling within the scope of the claims, and embodiments other than the ones shown may include some or all of the features of the depicted embodiments. For example, elements may be omitted or combined as a unitary structure, and/or connections may be substituted. Further, where appropriate, aspects of any of the examples described above may be combined with aspects of any of the other examples described to form further examples having comparable or different properties and/or functions and addressing the same or different problems. Similarly, it will be understood that the benefits and advantages described above may relate to one embodiment or may relate to several embodiments.

The claims are not intended to include, and should not be interpreted to include, means plus-or step-plus-function limitations, unless such a limitation is explicitly recited in a given claim using the phrase(s) “means for” or “step for,” respectively.

1. A tailgate pad comprising:
an inside panel;
an outside panel; and
a folding panel joining the inside panel to the outside panel, the folding panel comprising:
a width;
a length that is smaller than the width;
pads that extend along the width for at least 90% of the width; and
one or more grooves, each extending along the width and separating adjacent ones of the pads in the lengthwise direction such that the adjacent pads are displaceable relative to one another about an axis aligned with the groove.

2. The tailgate pad of claim 1, wherein each of the groove(s) has a depth that is between 10 and 75 millimeters (mm).

3. The tailgate pad of claim 1 or 2, wherein the folding panel is configured such that at least one of the pads is removable from the folding panel.

4. A tailgate pad comprising:
an inside panel;
an outside panel; and
a folding panel joining the inside panel to the outside panel, the folding panel comprising:
a width;
a length that is smaller than the width; and
pads extending along the width;
wherein the folding panel is configured such that at least one of the pads is removable from the folding panel.

5. The tailgate pad of claim 3 or 4, wherein the at least one removable pad extends along the width of the folding panel for at least 50%, optionally at least 90%, of the width of the folding panel.

6. The tailgate pad of any of claims 3-5, wherein the folding panel defines a sleeve configured to removably receive the at least one removable pad.

7. The tailgate pad of any of claims 1-6, wherein at least one of the pads extends along the width of the folding panel for at least 90% of the width of the folding panel.

8. The tailgate pad of any of claims 1-7, wherein each of the pads extends along the width of the folding panel for at least 90% of the width of the folding panel.

9. The tailgate pad of any of claims 1-8, wherein each of the pads has a thickness that is between 10 and 75 mm.

10. The tailgate pad of any of claims 1-9, wherein at least one of the pads has an end with a thickness that tapers.

11. The tailgate pad of any of claims 1-10, wherein at least one of the pads has a width that is at least 1.10 times a width of at least one other of the pads.

12. The tailgate pad of any of claims 1-11, wherein, for adjacent ones of the pads in the lengthwise direction, one of the adjacent pads has a width that is at least 1.10 times a width of the other of the adjacent pads.

13. The tailgate pad of any of claims 1-12, comprising:
straps configured to secure one or more items relative to the folding panel;
wherein the folding panel is configured to be coupled to the straps along top(s) of one or more of the pads.

14. The tailgate pad of claim 13, wherein the folding panel is configured to be coupled to the straps along the tops of pads that are spaced from one another in the lengthwise direction.

15. The tailgate pad of any of claims 1-14, wherein the pads comprise at least three pads.

16. The tailgate pad of any of claims 1-15, wherein the outside panel includes pads that extend along a width of the outside panel.

17. The tailgate pad of claim 16, wherein:
a thickness of a first one of the pads of the outside panel is between 1.1 and 3.0 times a thickness of a second one of the pads of the outside panel; and
the first pad is disposed closer to the folding panel than is the second pad.

18. The tailgate pad of any of claims 1-17, wherein:
the outside panel defines an opening through the outside panel; and
the tailgate pad includes a cover configured to selectively cover the opening.

19. The tailgate pad of any of claims 1-18, comprising a storage pocket coupled to the inside panel.

20. The tailgate pad of any of claims 1-19, comprising straps configured to couple the inside panel to the outside panel.

21. A method for installing a tailgate pad, the method comprising disposing a tailgate pad over a tailgate such that:
an inside panel of the tailgate pad overlies a bed-facing surface of the tailgate;
an outside panel of the tailgate pad overlies an exterior-facing surface of the tailgate; and
a folding panel of the tailgate pad that joins the inside panel to the outside panel:
overlies a top of the tailgate; and
adjacent ones of pads of the folding panel that extend along a width of the tailgate are angularly displaced relative to one another.

22. The method of claim 21, wherein a portion of the folding panel overlies the exterior-facing surface of the tailgate or the bed-facing surface of the tailgate.

23. The method of claim 21 or 22, wherein the adjacent pads are angularly displaced relative to one another by an angle of at least 30 degrees.

24. The method of any of claims 21-23, wherein the adjacent pads are separated by a groove of the folding panel.

25. The method of any of claims 21-24, comprising removing at least one of the pads from the folding panel.
